(19) United States
(12) Patent Application Publication
(10) Pub. No.: US 2013/0228556 A1
(43) Pub. Date: Sep. 5, 2013

(54) PORTABLE APPARATUS, PARTICULARLY FOR WELDING MACHINE AND PLASMA CUTTING

(71) Applicant: SEGALA BRUNO S.R.L., Sandrigo (IT)

(72) Inventor: Bruno SEGALA, SANDRIGO (IT)

(73) Assignee: SEGALA BRUNO S.R.L., SANDRIGO (IT)

(21) Appl. No.: 13/680,149

(22) Filed: Nov. 19, 2012

(30) Foreign Application Priority Data
Mar. 2, 2012 (IT) PD2012A000058

(51) Int. Cl. B23K 10/00; B23K 10/02

(52) U.S. Cl. CPC B23K 10/00; B23K 10/02
USPC 219/121.39; 219/121.45

(57) ABSTRACT

A portable apparatus, particularly for plasma welding or cutting, comprising a box-like body which contains an electronic power board, a flexible torch holder hose extending from the box-like body and terminating in the torch, for plasma welding or cutting.

The box-like body has an accommodation receptacle for the torch and for at least part of the torch holder hose, which is closed by a corresponding cover.

The present invention relates to a portable apparatus, particularly for plasma welding or cutting.

### BACKGROUND OF THE INVENTION

Portable welding apparatuses, both for the various principal methods of arc welding (MMA, TIG, MIG/MAG and ‘gasless’ Mig) and for resistance welding, and also portable apparatuses for plasma cutting, are nowadays increasingly widespread and appreciated for their combination of quality, high functionality, low encumbrances and ease of transport.

Such portable apparatuses generally comprise a box-like body that contains an electronic power board, an optional receptacle for the welding wire, for example for a MIG/MAG welder, and a canister for the shielding gas. A flexible hose extends from such box-like body and terminates in the welding torch, or in the plasma cutting torch.

Such portable apparatuses, although widespread and appreciated, have a major drawback which is linked to the management by the user of the long torch holder hose when the portable apparatus is not in use.

In fact such torch holder hose is usually left placed untidily about the box-like body, or it is partially rolled up around the box-like body as far as the flexibility of the hose permits, but with the result that as soon as the portable apparatus is lifted and moved, the hose unwinds in a disorderly manner, resulting in an encumbrance for the user who has to be careful not to trip over it.

Moreover, the torch holder hose, with the torch, if left outside the box-like body, is exposed to knocks, the accumulation of dust in the event of a long period of inactivity, and the aggression of atmospheric agents if the apparatus is stored in a poorly-protected environment or in the open.

In some recent models, the torch holder hose can be detached and removed from the box-like body, thus necessitating rolling up and stowing in another adapted container, which is different from and supplementary to the box-like body of the apparatus.

Similarly, management of the electric power supply cable of the portable apparatus is also left to the care of the user, who bears the burden of finding an ordered accommodation for such cable in periods when the apparatus is not in use.

### SUMMARY OF THE INVENTION

The aim of the present invention is to provide a portable apparatus, particularly for plasma welding or cutting, which is capable of overcoming the above-mentioned drawbacks of conventional portable apparatuses for plasma welding or cutting.

Within this aim, an object of the invention is to provide a portable apparatus in which the torch holder hose can be stowed in an ordered manner thus resulting in no encumbrance for the user during transport of the apparatus.

Another object of the invention is to provide a portable apparatus the electric power supply cable of which is easy to manage in an orderly manner.

A further object of the invention is to provide a portable apparatus with performance levels at least as high as those of similar conventional portable apparatuses.

A still further object of the invention is to provide a portable apparatus, particularly for plasma welding or cutting, which can be produced using known systems and technologies.

This aim and these and other objects which will become better evident hereinafter are achieved by a portable apparatus, particularly for plasma welding or cutting, comprising a box-like body which contains an electronic power board, a flexible torch holder hose extending from said box-like body and terminating in the torch, for plasma welding or cutting, said portable apparatus being characterized in that said box-like body has a cover for closing an accommodation receptacle for said torch and for at least part of said torch holder hose.

### BRIEF DESCRIPTION OF THE DRAWINGS

Further characteristics and advantages of the invention will become better apparent from the description of two preferred, but not exclusive, embodiments of the portable apparatus according to the invention, illustrated by way of non-limiting example in the accompanying drawings wherein:

FIG. 1 is a perspective view of a portable welder according to the invention in a first embodiment thereof;

FIG. 2 is an additional perspective view of the welder in FIG. 1;

FIG. 3 is a perspective view of a portable plasma cutting apparatus according to the invention in a second embodiment thereof;

FIG. 4 is an additional perspective view of the apparatus in FIG. 3.

### DESCRIPTION OF THE PREFERRED EMBODIMENTS

With reference to the figures, a portable apparatus according to the invention, particularly for welding, is generally designated in the first embodiment thereof with the reference numeral 10.

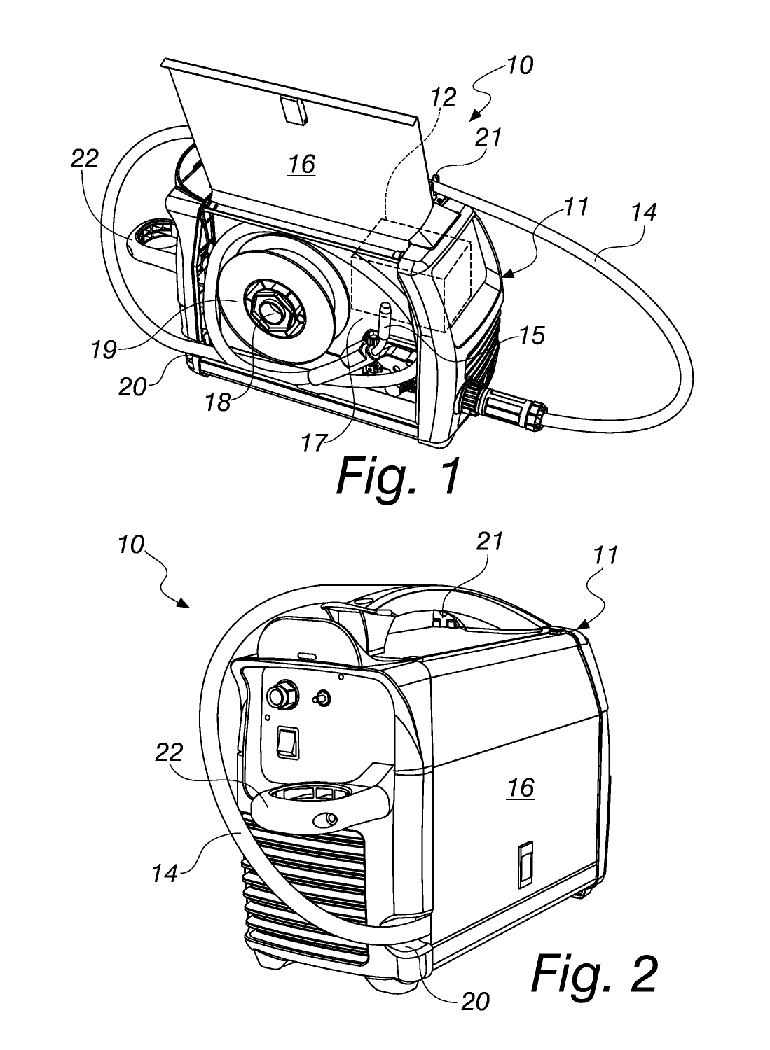

The portable welding apparatus 10 comprises a box-like body 11 which contains an electronic power board 12, which is shown in dotted lines in FIG. 1 and should be understood as being of a known type.

From such box-like body 11 a flexible torch holder hose 14 extends which terminates in the welding torch 15.

The particularity of the portable apparatus 10 consists in that the box-like body 11 has a cover 16 for closing an accommodation receptacle 17 for the welding torch 15 and for at least part of the torch holder hose 14.

FIG. 1 shows an example of the portable apparatus 10 for wire-type welding, and thus also present in the receptacle 17 there is for example, conveniently pivoted with means of a known type, a pin 18, a spool of wire 19 for welding.

For the passage of the torch holder hose 14 inside the receptacle 17 in the box-like body 11, a recess 20 is formed in the box-like body 11, at the edge of the cover 16.

In a different embodiment of the invention, not shown for the sake of simplicity, the passage of the hose 14 toward the interior of the receptacle 17 is made possible by a recess which is formed in the edge of the cover 16.

The cover 16 is advantageously hinged along one edge to the rest of the shell that forms the box-like body 11.

So that the section of hose 14 that remains outside the receptacle 17 does not hang down untidily, on the upper part of the box-like body 11 a hose holder fork 21 is provided to which the hose 14 can be coupled reversibly.

A canister support ring 22 for the canister of shielding gas also extends from the box-like body 11.

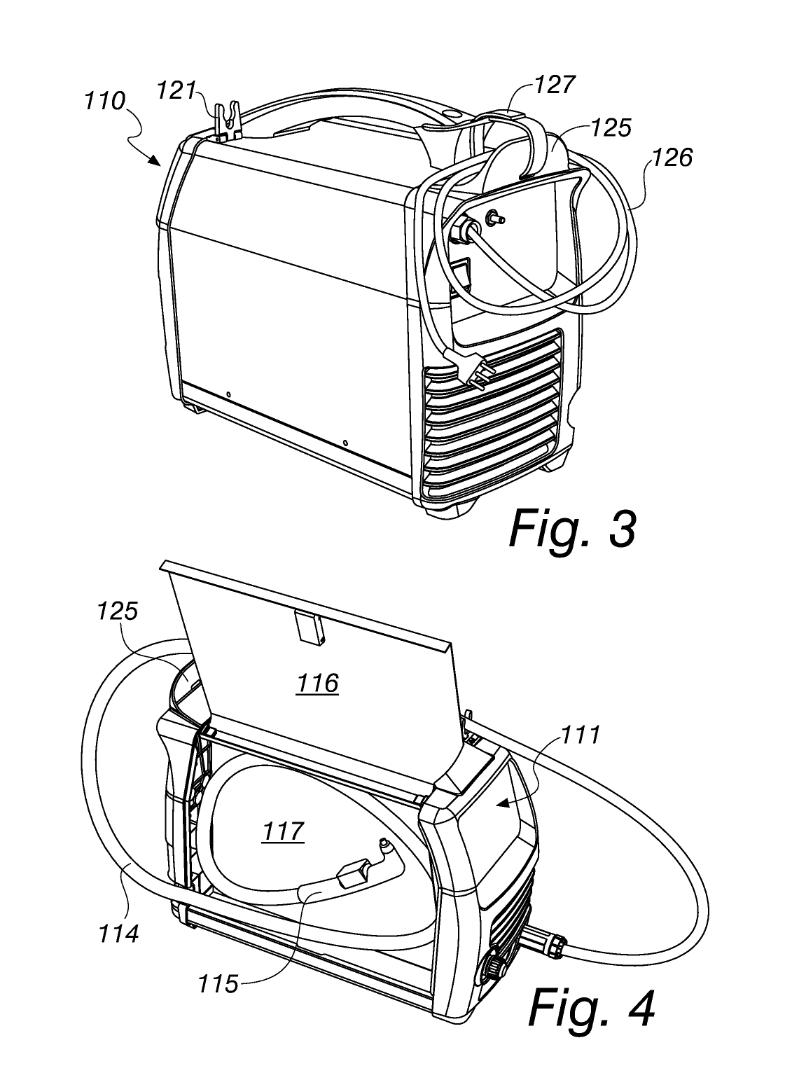

FIGS. 3 and 4 show an example of a second embodiment of the portable apparatus according to the invention, for plasma cutting, which is designated with the reference numeral 110.

The apparatus 110 has a box-like body 111, with a cover 116 which is pivoted in the manner of a door leaf, and a receptacle 117 which is free from the spool of wire, and thus able to contain one or more windings of hose 114 with a torch 115 for plasma cutting.

In FIG. 3 the hose holder fork 121 is clearly visible.

In such second embodiment the presence of an upper shoulder 125 is clearly shown that is adapted for winding the electric power supply cable 126.

With the aid of a band which can be opened and closed 127, for example a Velcro® ribbon, the supply cable 126 can easily be collected in an orderly manner on the upper shoulder 125, making it even simpler to manage and transport the portable apparatus according to the invention.

In practice it has been found that the invention fully achieves the intended aim and objects.

In particular, with the invention a portable apparatus, particularly for plasma welding or cutting, is made available in which the torch holder hose is stowed in an orderly manner thus resulting in no encumbrance for the user when the apparatus is not in use and being transported.

Moreover, with the invention a portable apparatus is made available in which the electric power supply cable is also easy to manage in an orderly manner.

Moreover, with the invention a portable apparatus is made available with performance levels at least as high as those of similar conventional portable apparatuses, the internal parts being understood to be be of known type.

In addition, with the invention a portable apparatus is made available which can be produced using known systems and technologies.

The invention thus conceived is susceptible of numerous modifications and variations, all of which are within the scope of the appended claims. Moreover, all the details may be substituted by other, technically equivalent elements.

In practice the materials employed, as well as the contingent dimensions and shapes, may be any according to requirements and to the state of the art.

The disclosures in Italian Patent Application No. PD2012A000058 from which this application claims priority are incorporated herein by reference.

What is claimed is:

1. A portable apparatus, particularly for plasma welding or cutting, comprising a box-like body which contains an electronic power board, a flexible torch holder hose extending from said box-like body and terminating in the torch, for plasma welding or cutting, wherein said box-like body has an accommodation receptacle for said torch and for at least part of said torch holder hose which is closed by a corresponding cover.

2. The portable apparatus according to claim 1, wherein a spool of welding wire is present in said receptacle.

3. The portable apparatus according to claim 1, further comprising, for the passage of the torch holder hose inside the receptacle in the box-like body, a recess which is formed in said box-like body, at the edge of the cover.

4. The portable apparatus according to claim 1, wherein said cover is hinged along one edge to the rest of the shell that forms the box-like body.

5. The portable apparatus according to claim 1, wherein on the upper part of the box-like body there is a hose holder fork to which the hose can be coupled reversibly.

6. The portable apparatus according to claim 1, further comprising an upper shoulder that is adapted for winding the electric power supply cable.
